(19) United States
(12) Patent Application Publication
(10) Pub. No.: US 2015/0212573 A1
(43) Pub. Date: Jul. 30, 2015

(54) STORING PRINT JOBS RECEIVED DURING SLEEP MODE

(71) Applicant: XEROX CORPORATION, Norwalk, CT (US)

(72) Inventors: Richard Bradford, Hitchin (GB); Peter Granby, Stevenage (GB); Stephen Foster, Barkway (GB); Wayne Rudge, Reading (GB); John A. Kerslake, Stevenage (GB); Christopher D. Olliffe, Berkhamsted (GB)

(73) Assignee: XEROX CORPORATION, Norwalk, CT (US)

(21) Appl. No.: 14/165,854

(22) Filed: Jan. 28, 2014

(51) Int. Cl. G06F 1/32

(52) U.S. Cl. CPC G06F 1/3284

(57) ABSTRACT

Methods and devices automatically and regularly transition a printing apparatus between a full-on power mode and a full-sleep power mode based on a previously established sleep mode schedule. Such methods and devices also automatically and regularly maintain the printing apparatus in the full-sleep power mode during a previously scheduled sleep mode interval except in response to the communications port receiving a received print job. Then, in response to the communications port receiving the received print job during the previously scheduled sleep mode interval, the methods and devices herein automatically transition from the full-sleep power mode to the second sleep power mode, automatically store the received print job in the non-transitory storage medium while in the second sleep power mode, and automatically return to the full-sleep power mode after completing the process of storing the received print job (without transitioning to the full-on power mode).

### BACKGROUND

Systems and methods herein generally relate to printers and their operations, and more particularly to printers that utilize sleep modes to conserve power.

The reduction of energy consumption is becoming a major issue in many areas. In addition to high quality solutions, customers are expecting “greener” products. In view of this, manufacturers of devices, such as printing devices, are making greater use of power-saving modes to allow their devices to consume less power. Power saving modes are reduced-power modes that use less power than ready modes; however, in power saving mode, most device functions are not available. When entering power-saving modes, most devices disconnect the power being supplied to all but a few devices needed to recover from the power saving mode.

For example, an “active power mode” (sometimes referred to as a full-on or operational mode) can be defined as the mode in which the device, while connected to a power source, is producing useful work. A “sleep mode” (sometimes referred to as a reduced-power mode) is a lower power state that a device enters automatically after a period of inactivity or by manual selection. A device with sleep capability can quickly “wake” in response to inputs. Devices may have more than one sleep mode (full-sleep, light-sleep, etc.).

Such power saving sleep modes can be, for example, begun when the device has not received any input from users or other devices within a specific time period (referred to commonly as a “time-out” period). Such sleep modes generally start a routine that saves certain information in the storage medium, selects which items will be disconnected from the power supply, resets various flags, etc., and then disconnects the power supply from selected elements of the device that will not be powered during the sleep mode.

The lowest power consumption mode, which is usually controlled by a hard switch or button, and may persist for an indefinite time, even when the device is connected to the main electricity supply, is an “off mode” and is different than a sleep mode. The off mode usually requires user action to change and requires a longer time to become fully operational, while the device can usually automatically return to the operational mode from a sleep mode more quickly and without user intervention.

Thus, power saving sleep modes only supply power to a few device elements to save power, yet allow the device to return to full operational mode (active mode) more quickly when compared to the time needed to reach full operational mode from an off mode (where substantially all systems are disconnected from the power supply). The active power mode is one that provides the fastest operation, provides availability of all features, and consumes the most power. Different power-saving modes consume different amounts of power, but all power saving modes consume less than the active mode, which consumes the most power, and power saving sleep modes are therefore beneficial to the environment and for cost savings.

Often, a printing device will automatically fully wake up from a power saving sleep mode whenever a facsimile or print job is received. This can waste energy, which is undesirable. This automatic wake-up can also cause security concerns if confidential documents are received or printed when a machine is unattended. Further, if printing machines operate at inconvenient times, this may cause user dissatisfaction due to noise being produced during periods when a quiet environment is desired.

### SUMMARY

An exemplary printing apparatus herein includes a printing engine operatively (meaning directly or indirectly) connected to a processor. The printing engine prints marks on media to execute electronic print requests. Also, a non-transitory storage medium and a communications port are operatively connected to the processor. The non-transitory storage medium stores received electronic print requests and a previously established sleep mode schedule (e.g., scheduled time period(s) of a day, a week, a month, and/or a year during which sleep power modes will be engaged for a specific machine). The communications port receives the electronic print requests from devices external to the printing apparatus. In addition, a power supply is operatively connected to the processor, the printing engine, the non-transitory storage medium, and the communications port. The processor controls the connections between the power supply and the printing engine, between the power supply and the communications port, and between the power supply and the non-transitory storage medium to selectively supply power to such items according to the previously established sleep mode schedule.

Regarding the different power modes, during a “full-on” power mode, the processor connects the power supply to the printing engine, the communications port, and the non-transitory storage medium. During a “full-sleep” power mode, the processor connects the power supply to the communications port, but disconnects the power supply from the printing engine and the non-transitory storage medium. During a “second” sleep power mode (which consumes less power than the full-on power mode, but consumes more power than the full-sleep power mode) the processor connects the power supply to the communications port and the non-transitory storage medium, but disconnects the power supply from the printing engine. The processor regularly transitions between the full-on power mode and the full-sleep power mode based on the previously established sleep mode schedule (which can also be based on non-usage periods, in addition to times of day, etc.).

The processor regularly maintains the printing apparatus in the full-sleep power mode during the previously established sleep mode scheduled time(s) except in response to the communications port receiving an electronic print request. More specifically, in response to the communications port receiving the received electronic print request during the previously scheduled sleep mode interval, the processor: transitions from the full-sleep power mode to the second sleep power mode; stores the received electronic print request in the non-transitory storage medium while in the second sleep power mode; and then returns to the full-sleep power mode (after completing the process of storing the received electronic print request) without transitioning to the full-on power mode. After transitioning back to the full-on power mode (based on the previously established sleep mode schedule) the processor retrieves the received electronic print request from the non-transitory storage medium and causes the printing engine to print the received electronic print request.

The printing apparatus also includes a graphic user interface operatively connected to the processor. The graphic user interface has at least one wake-up option on its various menus. Upon receiving user input to the wake-up option during a previously scheduled sleep mode interval, the processor returns to the full-on power mode.

Methods herein automatically: connect a power supply of a printing apparatus to a printing engine of the printing apparatus, a communications port of the printing apparatus, and a non-transitory storage medium of the printing apparatus during a full-on power mode; connect the power supply to the communications port, and disconnect the power supply from the printing engine and the non-transitory storage medium during a full-sleep power mode; and connect the power supply to the communications port and the non-transitory storage medium, and disconnect the power supply from the printing engine during a second sleep power mode.

These methods automatically and regularly transition the printing apparatus between the full-on power mode and the full-sleep power mode based on a previously established sleep mode schedule (e.g., scheduled time period(s) of a day, a week, a month, and/or a year). Such methods also automatically and regularly maintain the printing apparatus in the full-sleep power mode during the previously scheduled sleep mode interval except in response to the communications port receiving a received electronic print request. Then, in response to the communications port receiving the received electronic print request during the previously scheduled sleep mode interval, the methods herein automatically transition from the full-sleep power mode to the second sleep power mode, automatically store the received electronic print request in the non-transitory storage medium while in the second sleep power mode, and automatically return to the full-sleep power mode after completing the process of storing the received electronic print request (without transitioning to the full-on power mode).

After transitioning back to the full-on power mode according to the previously established sleep mode schedule, these methods automatically retrieve the received electronic print request(s) from the non-transitory storage medium that were stored during the previously scheduled sleep mode interval, and print the received electronic print request(s) using the printing engine. Such methods also return to the full-on power mode during the previously scheduled sleep mode interval upon receiving user input to a wake-up option on a graphic user interface of the printing apparatus.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram of various methods herein;

FIG. 2 is a flow diagram of various methods herein;

FIG. 3 is a flow diagram of various methods herein;

FIG. 4 is a schematic diagram illustrating devices herein.

### DETAILED DESCRIPTION

As mentioned above, a printing device may automatically transition to a full-on power mode from a power saving sleep mode whenever a facsimile or print job is received, and this can be undesirable. Therefore, the methods and devices herein provide configurable time settings that define sleep periods during which the machine will only partially wake up in order to save incoming facsimiles or print jobs, and then return to the low-power sleep state without printing the items. This saves the print jobs until someone physically interacts with the device, or the configured sleep time period expires.

The machine user interface allows the user to configure time periods (sleep cycles) during which the printing machine will not fully wake up from power saving mode when a print or fax job is received (e.g., overnight, over lunch, outside office hours). With systems and methods herein, the machine only partially wakes (with just the electronics being powered (e.g., processor/memory device, and not the user interface, print engine, or scanner being connected to the power supply) so as to be able to receive the print or fax job and save the images to disk, but not actually printing the job, after which the machine goes back to full-sleep power saving mode. With the devices and methods herein, when a machine is in sleep mode, the machine always stores the received print job without powering the user interface, printing engine, etc. When the device exits sleep mode (when the previously scheduled sleep mode time period ends or someone physically interacts the machine) the machine wakes up to full-on power mode and prints all the jobs that were saved to disk.

With the devices and methods herein, costs and energy consumption is reduced because it costs more and requires more power to wake a machine for every print job individually, and is more energy efficient to batch jobs up and print jobs together. This is particularly true for times of the day or week during which the machine will be unattended (and when an immediate printing action would be less worthwhile because no individual is waiting for the printed output). Also, if the machine encounters a problem, such as a jam or consumable resource depletion (paper or toner out condition) when unattended, the condition would not be corrected normally until after the previously scheduled sleep mode time period ends, because such sleep time intervals are usually scheduled when the machine is unattended. The devices and methods herein save substantial amounts of power, because the partial wake up mode does not cycle up the image output terminal or printing engine (which would require the warm-up of such high power consumption components as the fuser, cooling fans, scanner lamp etc.).

In addition, the devices and methods herein provide increased security by only printing during times when the printing device is normally attended (times outside the previously scheduled sleep mode intervals). For example, if the printing machine is unattended but in a public space over lunch time, and a confidential or a sensitive facsimile arrives, the devices and methods herein would save the confidential facsimile, and not print the confidential facsimile until the previously scheduled sleep mode interval ends (in this example lunch time ends, after which people who handle such confidential documents are normally monitoring the output of the machine).

Additionally, the devices and methods can prevent a printing machine from producing noise at undesirable times. For example, it may be undesirable for a printing machine to perform a printing operation (that produces noise) during overnight hours, or when a regularly scheduled presentation is occurring where the printing machine is located, etc. Therefore, in such situations, the previously established sleep mode schedule can be set by the user to include sleep mode during overnight hours, times and dates of regularly scheduled meetings, etc.

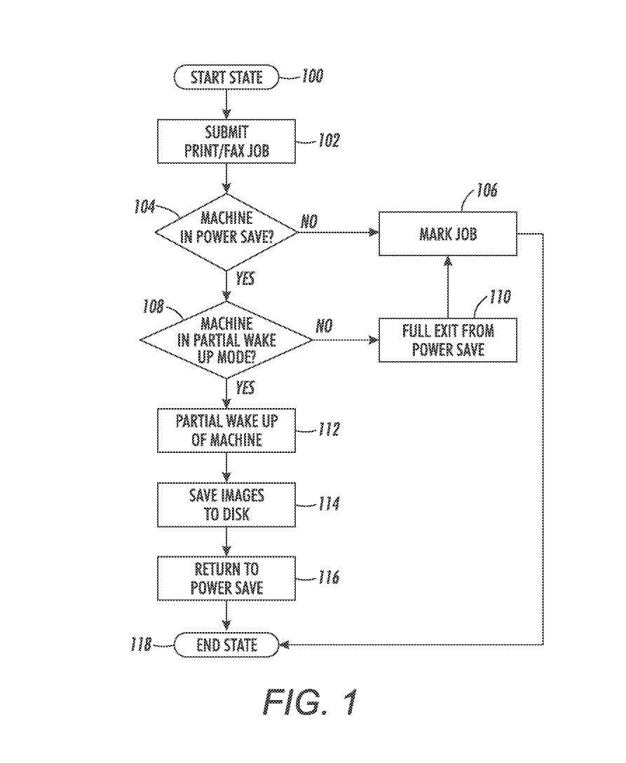

FIG. 1 is a flowchart illustrating the operation of various devices and methods herein, and begins with a printing machine in a starting state in item 100. In item 102, a print job or a facsimile is submitted to the printing machine, and the devices and methods herein determine whether the printing machine is in a power saving mode 104. If the printing machine is not in a power saving mode, processing proceeds to item 106 where markings are placed on print media to print the job.

However, if the printing machine is in a power saving mode, processing proceeds to item 108 to determine whether the current time and day would require a machine to only transition to a partial wake-up mode according to the previously established sleep mode schedule. If the current time and day is not within the previously established sleep mode schedule, processing proceeds to item 110, where the printing machine transitions to full-on power mode, and proceeds to item 106 to print the job.

In item 108, if it is determined that the current time and day is within the previously established sleep mode schedule, processing proceeds to item 112 to perform a partial wake-up of the printing machine. In item 114, the print job or facsimile images are saved to a disk, and in item 116, the printing machine then returns to the power saving mode. Item 118 represents the end state and is reached after completing processing in items 106 or 116.

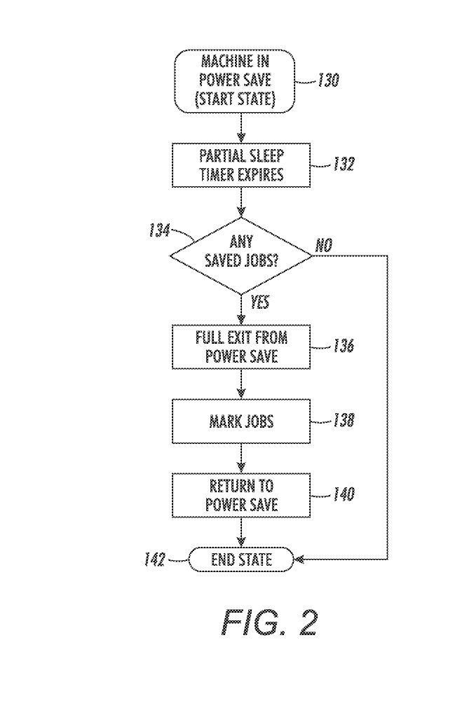

FIG. 2 represents the processing executed by the various devices and methods herein after various print jobs or facsimiles have been saved within machine memory during the previously scheduled sleep mode interval. More specifically, the machine is shown in a power saving state (which is the starting state for this example) in item 130. In item 132, the previously scheduled sleep mode interval ends (because the current time and day is outside the previously established sleep mode schedule). In item 134, the devices and methods herein check to see whether any print jobs or facsimiles have been saved within machine memory during the previously scheduled sleep mode interval. If not, processing moves to the end state in item 142.

However, if there are print jobs or facsimiles that have been saved within machine memory during the previously scheduled sleep mode interval, processing proceeds to item 136 where the printing machine exits the power saving mode and transitions to the full-on power mode. Then, in item 138, markings are placed on print media to print the job and the printing machine returns to the power saving state and item 140. Again, the end state of processing is shown as item 142.

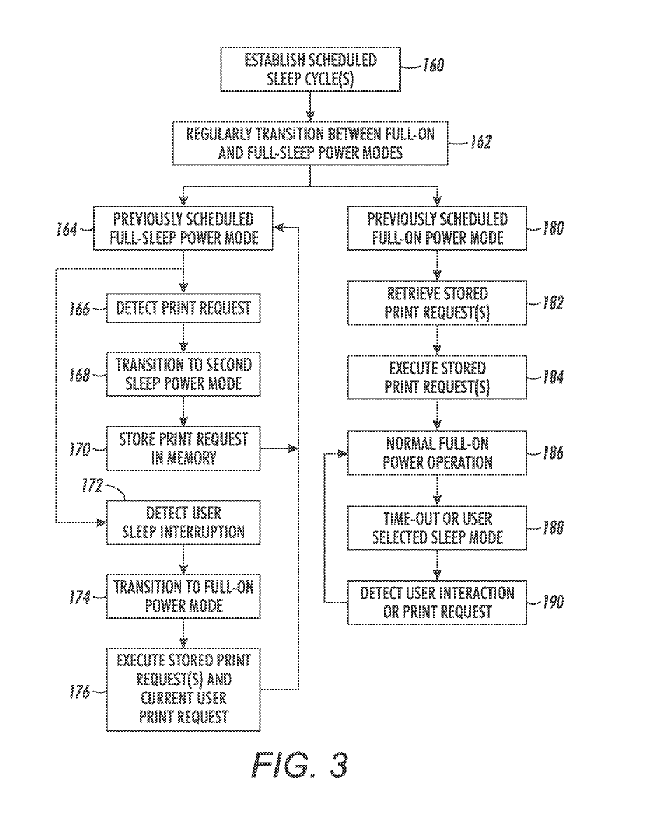

FIG. 3 is flowchart illustrating other aspects of exemplary methods herein. In item 160, a schedule for a sleep cycle is established. The printing machine has a default setting of sleeping which can be, for example, from 5 pm-7 am Monday-Friday and all day Saturday and Sunday. However, the devices and methods herein provide the user the option (through the graphic user interface of the printing device) to change such sleep schedule to execute as many sleep cycles (sleep intervals) as they would like over any calendar interval (minutes, hours, daily, weekly, monthly, yearly, etc.).

Then, in item 162, these methods automatically and regularly (cyclically) transition the printing apparatus between the full-on power mode and the full-sleep power mode based on the previously established sleep mode schedule (e.g., scheduled time period(s) of a day, a week, a month, and/or a year). During such regular power mode cycling, the methods herein engage in the full-sleep power mode (item 164) and the full-on power mode (item 180). More specifically, in item 164, these methods automatically connect the power supply to the communications port, and disconnect the power supply from the printing engine and the non-transitory storage medium during the full-sleep power mode. In item 180, these methods automatically connect a power supply of the printing apparatus to a printing engine of the printing apparatus, a communications port of the printing apparatus, and a non-transitory storage medium of the printing apparatus during the full-on power mode.

In item 166, such methods detect the communications port receiving an electronic print request while the printing machine is in one of the previously scheduled full-sleep power mode cycles (occurring according to the previously established sleep mode schedule). The electronic print request can by any instruction received from another computerized device to perform a printing action and includes, but is not limited to, print jobs, facsimiles, e-mail print requests, instant message print requests, internally machine generated print actions, etc. The electronic print request is distinguished from a user physically interacting with the printing device to perform a printing operation (such as a walk-up user copy operation) in which case the printing device immediately transitions to the full-on power mode to perform the walk-up user action (as shown in FIG. 1, discussed above).

In item 168, in response to the communications port receiving the electronic print request during the previously scheduled sleep mode interval (of the previously established sleep mode schedule) the methods herein automatically transition from the full-sleep power mode to a second sleep power mode. More specifically, in item 168, these devices and methods transition to the second sleep mode by connecting the power supply to the communications port and the non-transitory storage medium, and disconnecting the power supply from the printing engine (or simply not establishing a connection between (not connecting) the power supply and the printing engine).

After transitioning to the second sleep mode, in item 170 these methods automatically store the received electronic print request in the non-transitory storage medium (while in the second sleep power mode that supplies to the non-transitory storage medium). After completing the process of storing the received electronic print request in item 170, these methods automatically return to the full-sleep power mode (without transitioning to the full-on power mode) as shown by the return arrow in FIG. 3.

The devices and methods herein acknowledge a user's instruction to interrupt a sleep mode cycle, depending upon power and security settings. More specifically, item 172 represents a user operating a button or menu choice to interrupt a previously scheduled sleep mode interval (according to the previously established full-sleep power mode schedule). In response, the devices and methods herein transition to the full-on power mode in item 174. Further, such methods execute whatever printing requests the user currently makes of the printing device during the previously scheduled sleep mode interval interruption in item 176.

Also, if the security settings allow, because the printing engine and other associated printing components have been activated and warmed-up (caused by the user's sleep interruption print request in item 172) the methods and devices herein can print all print requests that were previously stored during the scheduled full-sleep power mode, to be as power efficient as possible by performing batch processing.

In one example of security settings, user interaction 172 can be allowed to cause the printing device to transition to full-on power mode 174, even when it is time for the previously scheduled full-sleep power mode 164 to be occurring; however, the printing device will only execute the user's current request and will not execute the stored print requests (in item 176) unless the user supplies proper authentication (such as entering a proper pin code, password, swiping a proper access card, etc.). After completing the process of printing in item 176, these methods automatically return to the full-sleep power mode as shown by the return arrow in FIG. 3.

After transitioning back to the full-on power mode 180 according to the previously established sleep mode schedule 162, these methods automatically retrieve the received electronic print request(s) from the non-transitory storage medium that were stored during the previously scheduled sleep mode interval (item 182) and print the received electronic print request(s) using the printing engine (item 184) in a single batch printing process (again, to be as power efficient as possible). Depending upon the security settings that have been selected by the user (through the printing device's graphic user interface) the batch printing of the stored print requests in item 184 may only occur if the user supplies proper authentication.

After printing the stored print requests in item 184, the printing device stays in a normal full-on power operation in item 186 where the printing device is fully warmed up and available for walk-up users to immediately print, or for print requests received by the communications port to be immediately printed. By “immediate” what is meant is that there is no delay caused by device warm-up or other similar “device wake-up” activities. At some point, the printing device may go unused longer than previously established “timeout” periods, and may transition into one of many sleep modes (one of which may be the full-sleep power mode described above); or the user may manually place the printing device in any such print mode, as shown in item 188. Item 190 illustrates user interaction, the receipt of a print request, etc., that occurs while the printing device is in the timeout sleep mode (or user selected sleep mode, etc.) in item 188. Upon detection of the new print request (or user interaction) the printing device does not store the print request for a future time, but instead immediately begins returning to the full-on power mode as shown by the return arrow in FIG. 3 and performs the requested printing action (as soon as all necessary elements are warmed up).

Therefore, the unscheduled sleep mode illustrated by item 188 is different than the previously scheduled sleep mode intervals illustrated by item 164 because the “unscheduled” sleep mode(s) in item 188 do not occur regularly according to a previously established daily, weekly, monthly, etc., schedule. Instead, the unscheduled sleep mode(s) 188 can occur at any time of the day, week, month (that is within the previously scheduled full-on power mode intervals). In other words, the scheduled sleep mode intervals 164 will regularly occur according to the previously scheduled sleep cycles 160 while, to the contrary, the unscheduled sleep mode(s) 188 occur whenever there is a sufficiently long non-usage period, upon user instructions, etc. Thus, the previously scheduled full-sleep power mode 164 described herein is a sleep mode that is different from, and in addition to, the timeout or user selected sleep mode shown in item 188. The systems and methods herein do not delay the wake-up process during unscheduled sleep modes when a print request is received; however, the systems and methods herein delay the wake-up process during scheduled sleep modes when a print request is received (and save the print request to be printed later, after the scheduled sleep mode ends).

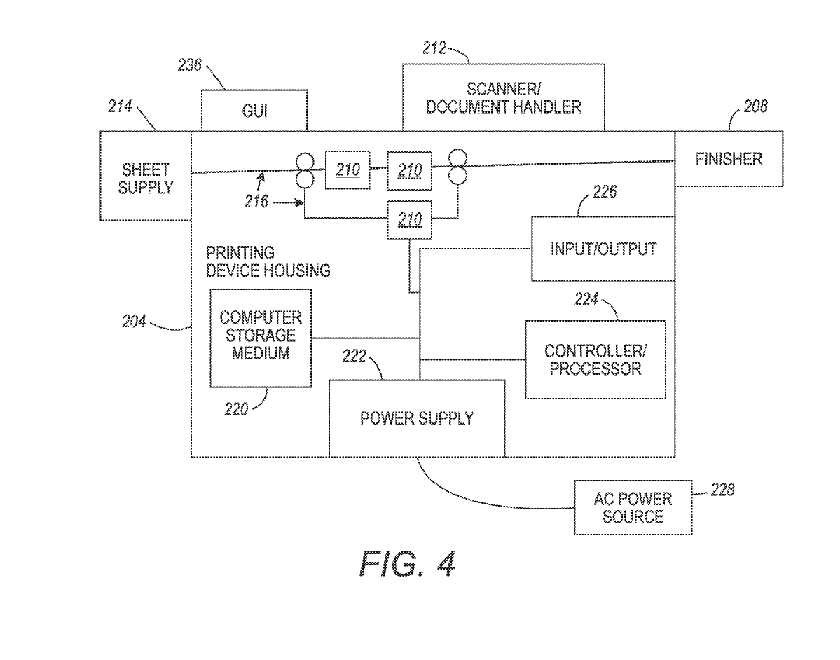

FIG. 4 illustrates a computerized device that is a printing device 204, which can be used with systems and methods herein and can comprise, for example, a printer, copier, multi-function machine, multi-function device (MFD), etc. The printing device 204 includes a controller/processor 224 and a communications port (input/output) 226 operatively connected to the processor 224 and to a computerized network external to the printing device 204. Also, the printing device 204 can include at least one accessory functional component, such as a graphic user interface assembly 236 that also operate on the power supplied from the external power source 228 (through the power supply 222).

The printing device 204 includes at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to a finisher 208 which can fold, staple, sort, etc., the various printed sheets. Also, the printing device 204 can include at least one accessory functional component (such as a scanner/document handler 212, etc.) that also operates on the power supplied from the external power source 228 (through the power supply 222).

The input/output device 226 is used for communications to and from the printing device 204. The processor 224 controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein. Thus, as shown in FIG. 4, a body housing has one or more functional components that operate on power supplied from an alternating current (AC) source 228 by the power supply 222. The power supply 222 can comprise a power storage element (e.g., a battery, etc).

Thus, FIG. 4 illustrates an exemplary printing apparatus 204 herein that includes the printing engine 210 operatively (meaning directly or indirectly) connected to the processor 224. The printing engine 210 prints marks on media to execute electronic print requests. Also, the non-transitory storage medium 220 and the communications port 226 are operatively connected to the processor 224. The non-transitory storage medium 220 stores received electronic print requests and the previously established sleep mode schedule (e.g., scheduled time period(s) of a day, a week, a month, and/or a year during which sleep power modes will be engaged for a specific machine). The communications port 226 receives the electronic print requests from devices external to the printing apparatus 204. In addition, the power supply 222 is operatively connected to the processor 224, the printing engine 210, the non-transitory storage medium 220, and the communications port 226. The processor 224 controls the connections between the power supply 222 and the printing engine 210, between the power supply 222 and the communications port 226, and between the power supply 222 and the non-transitory storage medium 220 to selectively supply 222 power to such items according to the previously established sleep mode schedule.

Regarding the different power modes, during a “full-on” power mode, the processor 224 connects the power supply 222 to the printing engine 210, the communications port 226, and the non-transitory storage medium 220. During a “full-sleep” power mode, the processor 224 connects the power supply 222 to the communications port 226, but disconnects (or does not connect) the power supply 222 from the printing engine 210 and the non-transitory storage medium 220. During a “second” sleep power mode (which consumes less power than the full-on power mode, but consumes more power than the full-sleep power mode) the processor 224 connects the power supply 222 to the communications port 226 and the non-transitory storage medium 220, but disconnects (or does not connect) the power supply 222 from the printing engine 210. The processor 224 regularly transitions between the full-on power mode and the full-sleep power mode based on the previously established sleep mode schedule. Unscheduled sleep modes (which are different than the previously scheduled sleep mode intervals described herein because the unscheduled sleep mode does not occur regularly according to a previously established schedule) that are based on non-usage periods, user instructions, etc., can be used by devices and methods herein, in addition to the previously scheduled sleep mode intervals.

The processor 224 regularly maintains the printing apparatus 204 in the full-sleep power mode during the previously scheduled sleep mode interval(s) except in response to the communications port 226 receiving an electronic print request. More specifically, in response to the communications port 226 receiving the received electronic print request during a previously scheduled sleep mode interval, the processor 224: transitions from the full-sleep power mode to the second sleep power mode; stores the received electronic print request in the non-transitory storage medium 220 while in the second sleep power mode; and then returns to the full-sleep power mode (after completing the process of storing the received electronic print request) without transitioning to the full-on power mode. After transitioning back to the full-on power mode (based on the previously established sleep mode schedule) the processor 224 retrieves the received electronic print request from the non-transitory storage medium 220 and causes the printing engine 210 to print the received electronic print request.

The printing apparatus 204 also includes a graphic user interface 236 operatively connected to the processor 224. The graphic user interface 236 has at least one wake-up option on its various menus. Upon receiving user input to the wake-up option during the previously scheduled sleep mode interval, the processor 224 returns to the full-on power mode to perform actions according to the user's instructions.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, processors, etc.) are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes. The terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A printing apparatus comprising:
a processor;
a printing engine operatively connected to said processor, said printing engine printing marks on media to execute electronic print requests;
a non-transitory storage medium operatively connected to said processor, said non-transitory storage medium maintaining a previously established sleep mode schedule;
a communications port operatively connected to said processor, said communications port receiving said electronic print requests from devices external to said printing apparatus; and
a power supply operatively connected to said processor, said printing engine, said non-transitory storage medium, and said communications port,
said processor regularly maintaining said printing apparatus in a full-sleep power mode according to said previously established sleep mode schedule except in response to said communications port receiving a received electronic print request of said electronic print requests,
said processor disconnecting said power supply from said printing engine and said non-transitory storage medium during said full-sleep power mode, and
in response to said communications port receiving said received electronic print request during a previously scheduled sleep mode interval of said previously established sleep mode schedule, said processor:
transitioning from said full-sleep power mode to a second sleep power mode by connecting said power supply to said non-transitory storage medium;
storing said received electronic print request in said non-transitory storage medium while in said second sleep power mode; and
returning to said full-sleep power mode after completing said storing said received electronic print request.

2. The printing apparatus according to claim 1, said returning to said full-sleep power mode after completing said storing said received electronic print request being performed by said processor without transitioning to a full-on power mode.

3. The printing apparatus according to claim 1, said previously established sleep mode schedule comprising time periods of at least one of a day, a week, a month, and a year.

4. The printing apparatus according to claim 1, said processor regularly transitioning said printing apparatus between a full-on power mode and said full-sleep power mode based on said previously established sleep mode schedule.

5. The printing apparatus according to claim 1, further comprising a graphic user interface operatively connected to said processor, said graphic user interface comprising a wake-up option, said processor returning to a full-on power mode during said previously scheduled sleep mode interval upon receiving user input to said wake-up option.

6. The printing apparatus according to claim 1, said processor controlling a connection between said power supply and said printing engine, a connection between said power supply and said communications port, and a connection between said power supply and said non-transitory storage medium.

7. The printing apparatus according to claim 1, after transitioning to a full-on power mode based on said previously established sleep mode schedule, said processor retrieving said received electronic print request from said non-transitory storage medium and causing said printing engine to print said received electronic print request.

8. A printing apparatus comprising:
a processor;
a printing engine operatively connected to said processor, said printing engine printing marks on media to execute electronic print requests;
a non-transitory storage medium operatively connected to said processor, said non-transitory storage medium maintaining a previously established sleep mode schedule;
a communications port operatively connected to said processor, said communications port receiving said electronic print requests from devices external to said printing apparatus; and
a power supply operatively connected to said processor, said printing engine, said non-transitory storage medium, and said communications port,
said processor connecting said power supply to said printing engine, said communications port, and said non-transitory storage medium during a full-on power mode,
said processor connecting said power supply to said communications port, and disconnecting said power supply from said printing engine and said non-transitory storage medium during a full-sleep power mode,
said processor connecting said power supply to said communications port and said non-transitory storage medium, and disconnecting said power supply from said printing engine during a second sleep power mode,
said processor regularly maintaining said printing apparatus in said full-sleep power mode based on said previously established sleep mode schedule except in response to said communications port receiving a received electronic print request of said electronic print requests, and
in response to said communications port receiving said received electronic print request during a previously scheduled sleep mode interval of said previously established sleep mode schedule, said processor:
transitioning from said full-sleep power mode to said second sleep power mode;
storing said received electronic print request in said non-transitory storage medium while in said second sleep power mode; and
returning to said full-sleep power mode after completing said storing said received electronic print request.

9. The printing apparatus according to claim 8, said returning to said full-sleep power mode after completing said storing said received electronic print request being performed by said processor without transitioning to said full-on power mode.

10. The printing apparatus according to claim 8, said previously established sleep mode schedule comprising time periods of at least one of a day, a week, a month, and a year.

11. The printing apparatus according to claim 8, said processor regularly transitioning said printing apparatus between said full-on power mode and said full-sleep power mode based on said previously established sleep mode schedule.

12. The printing apparatus according to claim 8, further comprising a graphic user interface operatively connected to said processor, said graphic user interface comprising a wake-up option, said processor returning to said full-on power mode during said previously scheduled sleep mode interval upon receiving user input to said wake-up option.

13. The printing apparatus according to claim 8, said processor controlling a connection between said power supply and said printing engine, a connection between said power supply and said communications port, and a connection between said power supply and said non-transitory storage medium.

14. The printing apparatus according to claim 8, after transitioning to said full-on power mode based on said previously established sleep mode schedule, said processor retrieving said received electronic print request from said non-transitory storage medium and causing said printing engine to print said received electronic print request.

15. A method comprising:
automatically connecting a power supply of a printing apparatus to a printing engine of said printing apparatus, a communications port of said printing apparatus, and a non-transitory storage medium of said printing apparatus based on said printing apparatus being in a full-on power mode;
automatically connecting said power supply to said communications port, and disconnecting said power supply from said printing engine and said non-transitory storage medium based on said printing apparatus being in a full-sleep power mode;
automatically connecting said power supply to said communications port and said non-transitory storage medium, and disconnecting said power supply from said printing engine based on said printing apparatus being in a second sleep power mode;
automatically and regularly maintaining said printing apparatus in said full-sleep power mode during a previously scheduled sleep mode interval of a previously established sleep mode schedule except in response to said communications port receiving a received electronic print request; and
in response to said communications port receiving said received electronic print request during said previously established sleep mode schedule:
automatically transitioning from said full-sleep power mode to said second sleep power mode;
automatically storing said received electronic print request in said non-transitory storage medium while in said second sleep power mode; and
automatically returning to said full-sleep power mode after completing said storing said received electronic print request.

16. The method according to claim 15, said returning to said full-sleep power mode after completing said storing said received electronic print request being performed without transitioning to said full-on power mode.

17. The method according to claim 15, said previously established sleep mode schedule comprising time periods of at least one of a day, a week, a month, and a year.

18. The method according to claim 15, further comprising automatically and regularly transitioning said printing apparatus between said full-on power mode and said full-sleep power mode based on said previously established sleep mode schedule.

19. The method according to claim 15, further comprising returning to said full-on power mode during said previously scheduled sleep mode interval upon receiving user input to a wake-up option on a graphic user interface of said printing apparatus.

20. The method according to claim 15, further comprising, after transitioning to said full-on power mode based on said previously established sleep mode schedule, automatically retrieving said received electronic print request from said non-transitory storage medium and causing said printing engine to print said received electronic print request.
